(19) United States
(12) Patent Application Publication
(10) Pub. No.: US 2015/0290860 A1
(43) Pub. Date: Oct. 15, 2015

(54) ADDITIVE MANUFACTURE VIA HIGH ASPECT RATIO NOZZLES

(71) Applicant: Leon L. SHAW, Chicago, IL (US)

(72) Inventor: Leon L. SHAW, Chicago, IL (US)

(21) Appl. No.: 14/682,254

(22) Filed: Apr. 9, 2015

Related U.S. Application Data
(60) Provisional application No. 61/977,144, filed on Apr. 9, 2014.

(51) Int. Cl. B29C 47/14; B28B 1/00; B29C 67/00

(52) U.S. Cl. CPC B29C 47/14; B29C 67/0055; B29C 67/0085; B28B 1/001; B33Y 10/00

(57) ABSTRACT

Methods of manufacture involving feeding a quantity of an additive manufacture material, such as a slurry or paste, through a high aspect ratio (HAR) nozzle to fonn a disposed layer. The high aspect ratio nozzle has a major axis to minor axis aspect ratio of greater than one. Second or further layers of the same or different material may be disposed on or adjacent to previously disposed layers via the same high aspect ratio nozzle or via different means such as a different nozzle. Such different nozzle can be a second high aspect ratio nozzle.

### CROSS REFERENCE TO RELATED APPLICATION

This application claims the benefit of U.S. Provisional Patent Application, Ser. No. 61/977,144, filed on 9 Apr. 2014. The co-pending Provisional Patent Application is hereby incorporated by reference herein in its entirety and is made a part hereof, including but not limited to those portions which specifically appear hereinafter.

### BACKGROUND OF THE INVENTION

1. Field of the Invention

This invention relates generally to additive manufacture and, more particularly, to additive manufacture using High Aspect Ratio (HAR) nozzles.

2. Discussion of Related Art

Additive manufacture, also known as solid freeform fabrication, layered manufacture, or rapid prototyping, is a designation for a group of processes that produce or build parts point-by-point and/or layer-by-layer via additive formation steps. While such manufacture has been generally known for a number of years, such manufacture processing represents a substantial change in the process of the design and evolution in the manufacture of components.

Examples of multiple material and multiple layer components and devices commonly produced include solid oxide fuel cells (SOFCs), multi-layer ceramic capacitors (MLCCs), resistor-capacitor, inductor-capacitor, and varistor-capacitor multilayer combinations, and dye-sensitized solar cells. Tape casting is one widely used technique to fabricate many such multi-material, multi-layer devices, particularly for SOFCs and MLCCs. Tape casting, however, typically requires many subsequent processing steps, such as cutting, punching, stacking, and sometimes with screen printing. Furthermore, to facilitate these processing steps, considerable amounts or quantities of binders and plasticizers are usually added to the slip. The subsequent removal of these large quantities of additives such as through binder burnout often results in the formation of significant residual pores and/or defects during sintering. Moreover, the inclusion and use of such multiple processing steps commonly necessitates substantial work efforts directed to tasks such as part count, part handling, part transport from one machine to another, and part storage if multiple days are needed to complete multiple processing steps. Unfortunately, the cost of devices commonly increases with the required labor and space for tasks such as part count, part handling, part transport, and part storage. As a result of relatively expensive manufacturing processing and relatively high material costs, such processing and resulting products are typically more costly than desired.

At least in part in view of such shortcomings of prior processing techniques, research organizations and commercial companies have developed multiple (at least 24) different additive manufacturing techniques in the recent past. Unfortunately, although somewhat capable of making complex-geometry components, these previously developed methods typically suffer from lower than desired fabrication rates because components are fabricated via line-by-line and/or point-by-point. Thus, if a multi-layer, multi-material device is to be fabricated via such additive manufacturing methods, the cost of components will be extremely high.

While conventional additive manufacturing may provide a processing regime whereby one or more of the shortcomings of prior processing techniques can be reduced, minimized and/or avoided, a major roadblock to the large scale application of additive manufacturing has been the low fabrication rates associated or typically realized in such processing. As a result, additive manufacturing has generally been commercially limited to rapid prototyping applications.

In view of the above, there is a need and a demand for processing changes and/or improvements such as to permit the more widespread application and use of additive manufacturing.

### SUMMARY OF THE INVENTION

A general object of the invention is to provide improved additive manufacturing.

In accordance with one aspect of the development a method of manufacture is provided wherein a first quantity of a first additive manufacture material is fed through a first high aspect ratio (HAR) nozzle to form a first disposed layer. The first HAR nozzle has a major axis to minor axis aspect ratio of greater than one.

In accordance with another aspect of the invention, an improvement is provided in a method of additive manufacture wherein a slurry or paste additive manufacture material is processed to form a multi-layer object. In one embodiment, such an improvement can involve sequentially feeding individual quantities of the slurry or paste additive manufacture material through one or more HAR nozzles having a major axis to minor axis aspect ratio of greater than one to additively form the multi-layer object.

As described in greater detail below, through the use of High Aspect Ratio (HAR) nozzles the invention desirably overcomes, for the first time, the low fabrication rate barrier previously associated with or experienced in conventional additive manufacturing. Thus, through the invention, additive manufacturing can be or is made cost effective even for large-scale manufacture of multi-layer, multi-material components and devices.

Other objects and advantages will be apparent to those skilled in the art from the following detailed description taken in conjunction with the appended claims and drawings.

### BRIEF DESCRIPTION OF THE DRAWINGS

Objects and features of this invention will be better understood from the following description taken in conjunction with the drawings, wherein:

FIGS. 1a-1c illustrate examples of opening geometries of HAR nozzles useable in the practice of the invention, including:

FIG. 1a illustrates an elliptical shape opening;

FIG. 1b illustrates a rectangular shape opening with sharp corners; and

FIG. 1c illustrates a rectangular shaped opening with round corners;

FIG. 2 is a non-scale simplified schematic of a self-supported solid oxide fuel cell architecture with cross-flow configuration and 2 cells stacked together, in accordance with one embodiment of the invention;

FIG. 3 is an SEM image of a surface of a green-printed layer generated via 3D printing technology; and

FIG. 4 is an optical image of a plane produced using a HAR nozzle with only one micro-extrusion operation.

### DETAILED DESCRIPTION OF THE INVENTION

As described in greater detail below, the invention is directed to additive manufacturing using High Aspect Ratio (HAR) nozzles, with certain aspects of the invention believed to have particularly advantageous applicability to the manufacture, processing or formation of various multi-layer components and devices including, but not necessarily limited to multi-material multi-layer components and devices.

In one aspect, a method of manufacture involves feeding a quantity of an additive manufacture material through a HAR nozzle to form a disposed layer. Those skilled in the art and guided by the teachings herein provided will understand and appreciate that the broader practice of the invention is not necessarily limited to specific or particular additive manufacture materials. Additive manufacture materials useful in the practice of the invention can take any form that can be suitably processed via or through the selected HAR nozzle(s). Examples of typical or usual additive manufacture materials useful in the practice of the invention include slurries and pastes, including, for example, micro-extrudable slurries and pastes, i.e., slurries and pastes suited or adaptable for micro-extrusion processing.

Examples of suitable slurries and pastes that can be used in the practice of the invention may include: GDC (Ce_{0.9}Gd_{0.1}O_{1.95}); 1Yb10ScSZ (Yb_{0.02}Sc_{0.18}Zr_{0.80}O_{1.90}); LSM (La_{0.65}Sr_{0.30}MnO₃₋ₓ); SLT (Sr_{0.7}La_{0.2}TiO₃); LSGM ((La,Sr)(Ga,Mg)O₃); SSC (Sm_{0.5}Sr_{0.5}CoO₃); activated carbon (AC); graphene; graphite; LiPF₆ in EC/PC; liquid mixtures of LiPF₆ in EC/PC=1/1 v/v, ethoxylated trimethylolpropane triacrylate (ETPTA), and 2-hydroxy-2-methyl-1-phenyl-1-propanon (HMPP); Al₂O₃; Na₃MnCO₃PO₄; NaCrO₂; LiCoO₂; LiFePO₄; 1-methyl-2-pyrrolidinone (NMP); tetraglyme; poly(vinylidene) fluoride (PVDF) in NMP; PVDF in tetraglyme; and any mixtures of two or more of the above materials.

Additive manufacture processing herein provided, sometimes termed as “Heterogeneous-Object Rapid Prototyping” (HORP) coupled with HAR nozzles, desirably reduces or minimizes and preferably desirably eliminates otherwise normally practiced and required processes steps such as cutting, punching, stacking, screen printing, binder burnout, part count, part handling, part transport, and part storage because the subject additive manufacturing processing can fabricate a device via a single machine with high additive rates.

For example, forms can be produced, e.g., printed, in various 3D patterns using a subject HORP machine such as with two materials from two nozzles, for example.

Those skilled in the art and guided by the teachings herein provided will understand and appreciate that the term HAR nozzle as used herein generally refers to processing nozzle having an opening, e.g., a material discharge opening, in a selected geometric shape and having a major axis to minor axis aspect ratio of greater than one.

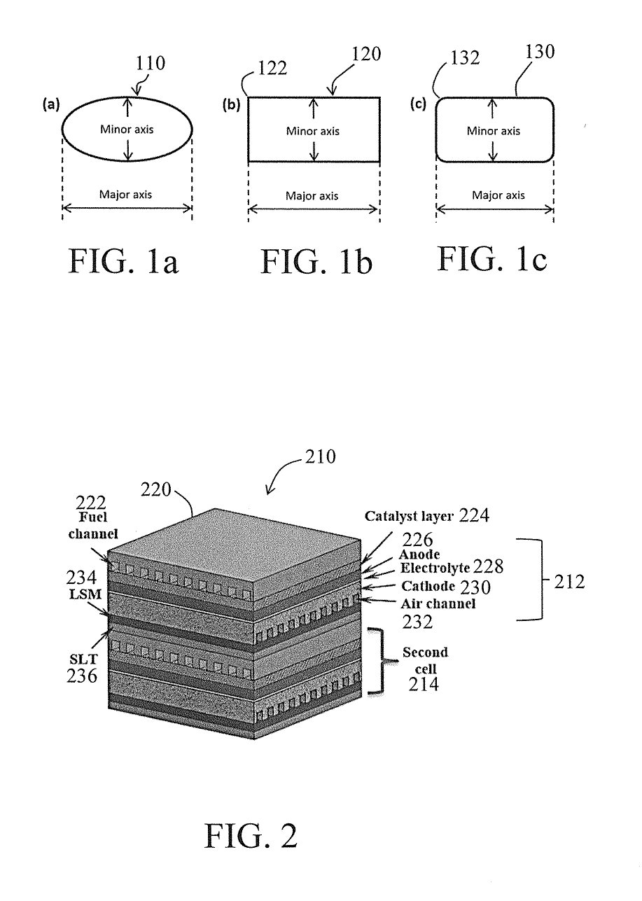

FIGS. 1a-1c illustrate some examples of various HAR nozzle opening geometries useable in the practice of the invention. Examples of various HAR nozzle opening geometries useable in the practice of the invention include an elliptical shape opening 110 (such as shown in FIG. 1a), a rectangular shape opening 120 with sharp corners 122 (such as shown in FIG. 1b), and a rectangular shaped opening 130 with round corners 132 (such as shown in FIG. 1c), for example. It is to be understood and appreciated, however, that various forms of suitable opening geometries having a major axis to minor axis aspect ratio of greater than one are possible, including but not necessarily limited to opening geometries that are modifications of or intermediaries of those shown in FIGS. 1a-1c and thus the broader practice of the invention is not necessarily limited to use with a particular or specific nozzle opening geometry.

Moreover, while the broader practice of the invention utilizes a HAR nozzle having a major axis to minor axis aspect ratio of greater than one, specific aspects or embodiments of the invention utilize HAR nozzles that satisfy additional limitations.

For example, in accordance with one aspect, a HAR nozzle having a major axis to minor axis aspect ratio of at least 1000 is used in the practice of the invention.

In accordance with one aspect, a HAR nozzle used in the practice of the invention has a major axis in a range of 0.001 mm to 500 mm.

In accordance with one aspect, a HAR nozzle used in the practice of the invention has a major axis in a range of 1 mm to 500 mm.

In accordance with one aspect, a HAR nozzle used in the practice of the invention has a major axis in a range of 5 mm to 50 mm.

In accordance with one aspect, a HAR nozzle used in the practice of the invention has a minor axis in a range of 0.0005 mm to 5 mm.

In accordance with one aspect, a HAR nozzle used in the practice of the invention has a minor axis in a range of 0.005 mm to 0.1 mm.

HAR nozzles useful in the practice of the invention can be made or formed from various different materials. For example, suitable HAR nozzles may be formed or constructed of plastics or metals; suitable metals can include steels, particularly stainless steels and Al alloys. Those skilled in the art and guided by the teachings herein provided are, however, to understand and appreciate that the broader practice of the invention is not necessarily limited to HAR nozzles formed or made from particular materials.

A key feature of HORP technology is its capability of handling multiple materials—an essential requirement for fabricating at least certain multi-material devices like certain Intermediate Temperature Fuel Cells (ITFCs). Using HORP technology, multiple ITFCs can be fabricated via a single HORP machine so that the processes of cutting, punching, stacking, screen printing, binder burnout, part count, part handling, part transport, and part storage can be eliminated.

HORP machines or assemblies useful in the practice of the invention can take different forms. For example, in accordance with one aspect a suitable HORP assembly may include a machine with the capability to mix two different slurries, e.g., slurries A and B, in situ during micro-extrusion. In accordance with another aspect, a suitable HORP assembly may include a machine equipped with multiple micro-extruders (e.g., 2, 3 or more) capable to deposit multiple (e.g., 2, 3, or more, respectively) different materials. In accordance with another aspect, a suitable HORP assembly may include a machine equipped with 2 or more micro-extruders, such as built on a CNC milling machine platform. In accordance with another aspect, a suitable HORP assembly may include or incorporate a gantry system such as to move one or more multiple micro-extruder assemblies on the X-Y plane, while the Z direction movement can be achieved by attaching linear stages to a movable beam. More specifically, to fabricate self-supported cells in one manufacturing step, a full-scale HORP machine, containing at least six (6) HAR nozzles to deposit 6 different planes and 3 arrays of many circular nozzles to deposit two gas channels and the support material is desired. Such a full-scale HORP machine can be built on a gantry system with a travel distance of 1,016×1,016 mm in the X-Y plane and 127 mm in the Z direction. The HAR nozzle assembly and circular nozzle assembly can be installed at both the front and back of the stage attached to the movable beam.

Additive manufacturing methods have capabilities of producing various 3D complex-geometry components such as including but not necessarily limited to fused deposition modeling (FDM) of a surgical planning model of a jaw; Tru-Surf (TM) processing to fabricate a dolphin statue; and 3D-printing (3DP) of complex structures such as architectural models, for example.

Although capable of making complex-geometry components, these and other prior additive manufacturing processing techniques generally experience low fabrication rates because components are fabricated via line-by-line and/or point-by-point processing. Consequently, for a multi-layer, multi-material device fabricated via such additive manufacturing methods, the cost of components will be extremely high.

In contrast, by coupling HAR nozzles with HORP technology, the costs of multi-layer, multi-material components and devices can be drastically reduced, e.g., reduced by several-hundred or thousand times.

A method of manufacture in accordance with one aspect involves:

feeding a first quantity of a first additive manufacture material through a first high aspect ratio (HAR) nozzle to form a first disposed layer, and

feeding an additional quantity of the first additive manufacture material through the first HAR nozzle to form a second layer disposed at least in part on or adjacent to the first disposed layer.

A method of manufacture in accordance with another aspect involves:

feeding a first quantity of a first additive manufacture material through a first high aspect ratio (HAR) nozzle to form a first disposed layer, and

feeding a second quantity of a second additive manufacture material through a second nozzle to form a second layer, wherein,

the second layer is disposed at least in part on or adjacent to the first disposed layer when the second layer is formed subsequent to the first disposed layer and

the first disposed layer is disposed at least in part on or adjacent to the second layer when the first disposed layer is formed prior to second layer.

In such an embodiment, the first additive manufacture material and the second additive manufacture material may comprise an identical slurry or paste. Alternatively, the first additive manufacture material and the second additive manufacture material may differs in composition and/or viscosity.

In one aspect, the second nozzle is desirably also a HAR nozzle having a major axis to minor axis aspect ratio of greater than one.

In another aspect, the second nozzle is desirably a circular nozzle, e.g., a nozzle having a discharge opening in circular cross section.

Thus, second or further layers of the same or different material may be disposed on or adjacent to previously disposed layers via the same high aspect ratio nozzle or via different means such as a different nozzle. Such a different nozzle can be a second high aspect ratio nozzle.

Turning to FIG. 2 there is shown a non-scale simplified schematic of a self-supported solid oxide fuel cell architecture, generally designated by the reference numeral 210, that can be formed via practice of the invention in accordance with one embodiment. More specifically, the cell architecture 210 provides or supports cross-flow configuration and includes 2 cells (212 and 214) stacked together such as fabricated via HORP technology, in accordance with one embodiment of the invention. The cell 212 is generally composed of a layer 220 such as forming multiple fuel channels 222; a catalyst layer 224; an anode layer 226; an electrolyte layer 228; a cathode layer 230, such as forming multiple oxidant or air channels 232, a LSM layer 234 and a SLT layer 236. The LSM and SLT bi-layer or the like can generally serve as oxide interconnects in the self-supported cell. They can offer stability and high conductivity in both oxidizing and reducing atmospheres.

In the illustrated embodiment, the cell 214 is shown as having the same general structure as the cell 212. Those skilled in the art and guided by the teachings herein provided will, however, understand and appreciate that the broader practice of the invention is not necessarily so limited as, for example, the invention can be practice to form or produce cell architectures that incorporate or include two or more different or dissimilar cell structures.

While FIG. 2 depicts such novel self-supported cell architecture with 2 cells stacked together, those skilled in the art and guided by the teachings herein provided will understand and appreciate that the broader practice of the invention is not necessarily so limited as, for example, cell architectures which include or incorporate multiple cells, for example, up to 10 to 20 cells or more in an architecture or module stack, can be produced or formed in accordance with the invention. Such self-supported cells having 10 to 20 cells stacked together as a stack module may find desirable application in subsequent assembly to form large ITFC stacks, for example. While FIG. 2 depicts the novel self-supported cell architecture with 2 cells stacked together, with 10 to 20 cells stacked together in one stack module, anode/electrolyte/cathode layers can be fabricated as thin as required by electrochemical function only (e.g., 2-5 μm for the electrolyte and 25 μm for both the anode and cathode), thereby reducing the expensive ceramic materials while enhancing the performance. Such cross-flow configurations can beneficially permit the fuel and oxidant supplies to be separated in two directions to make design and construction of sealing and gas distribution networks easier. In addition, a bi-layer oxide interconnect (LSM+SLT) in the self-supported cell can offer stability and high conductivity in both oxidizing and reducing atmosphere.

In the FIG. 2 the cell stack 210, carbon black (CB) slurry can be deposited at both air and fuel channel locations via HORP. In the subsequent sintering, CB can be burned out to create both air and fuel channels. If desired, 10 to 20 cells can be fabricated together in each stack module to provide the self-support function.

In accordance with one aspect of the invention, fabrication of multi-layer, multi-material devices like ITFCs via layer-by-layer methods creates a need for appropriate controlling software such as can or does contain geometric information of the device as well as its material composition information.

In accordance with one aspect of the invention, software permits linking the X-Y location with the on-and-off function of each HAR nozzle. The composition change from one location to another can be achieved by activating the appropriate nozzle(s) and turning off other nozzles since each nozzle holds specific slurry/paste with the pre-determined composition. Modeling, representation and nozzle path planning may appropriately include one or more of the following major steps: (i) creation of a 3D CAD file, (ii) discretization and formation of STL files, (iii) merging of STL files of different materials, (iv) slicing of the 3D model into 2.5D layers, and finally (v) creation of multi-nozzle path program (G-Code) to control micro-extruders with HAR or circular nozzles and their extrusion process.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

### Example 1

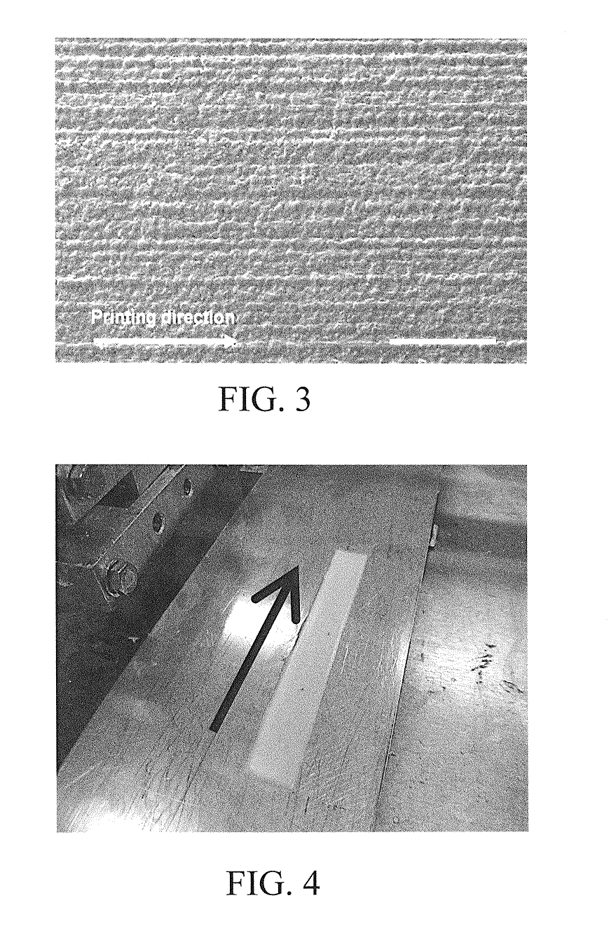

FIG. 3 is an SEM image of a surface of a green-printed layer generated via 3D printing technology

FIG. 3 shows a top view of the surface of a layer printed via an inkjet with a nozzle opening of 30 μm in diameter. The viewed surface has an area of approximately 3.0 mm by 4.6 mm which is composed of ˜40 printed lines along the printing direction, i.e., this layer is fabricated by ˜40 printing passes along the printing direction. Note that the thickness of the layer printed scales with the nozzle diameter. Thus, if a nozzle with a 5-μm opening is used to print a layer of ˜5 μm thick with the same area as that shown in FIG. 3, then this layer would require approximately 240 printing passes. This would make such manufacture of such multi-layer components or devices too costly. However, using HAR nozzles, in accordance with the invention as herein provided such as a nozzle with an opening of 5 μm×3,000 μm, only one printing pass would be needed, significantly increasing the fabrication rate, e.g., increasing the fabrication rate by about 240 times. If a larger area is to be fabricated (such as 150 mm×150 mm with a thickness of 5 μm), then 30,000 printing passes would be required if a circular nozzle of 5-μm in diameter is used. Through the practice of the invention and the use of an appropriately selected HAR nozzle, such manufacturing complexity can be significantly reduced and simplified. For example, through the use of a HAR nozzle with an opening of 5 μm×25,000 μm in accordance with the invention, such 30,000 printing passes can be readily reduced to 6 printing passes, leading to a 5000× increase in the fabrication rate.

### Example 2

FIG. 4 shows a plane printed on an aluminum plate using a HAR nozzle with one (1) printing pass, with the arrow indicating the direction of the micro-extrusion.

This printed plane was 100 μm thick, and would have required in the order of 100 printing passes if a circular nozzle of 100 μm in diameter were used. Studies to print large areas (e.g., 100,000×100,000 μm) by linking multiple printing passes and to print devices such as solid oxide fuel cells with multiple layers (e.g., including the cathode/electrolyte/anode) and each layer having its unique chemical composition are contemplated.

### Examples 3 and 4

### Micro-Extrusion of Single and Multi-Layered Objects Using HAR Nozzles

In these Examples, 3D objects composed of a single and multi-layer (e.g., three layers), respectively, were formed by practice of the subject invention via deposition of a micro-extrusion of a gadolinium doped ceria (GDC) slurry using a HAR nozzle of Wₐ=0.2 mm and. W_{b}=10 mm (where Wₐ and W_{b} are the dimensions of the HAR nozzle opening, width and length, respectively).

These examples demonstrate that multi-layered objects with the same composition can be fabricated rapidly via HAR technology and practice of the invention.

As will be appreciated, the invention can be similarly practiced forming similar multi-layer objects incorporating one or more layers of different composition.

Thus, in at least one aspect, the invention provides processing that couples HAR nozzles with HORP technology whereby multi-layer, multi-material components and devices can be fabricated via additive manufacturing in a cost-effective manner.

The invention is believed to have particular utility in the manufacture of a variety of multi-layer, multi-material components and devices including but not necessarily limited to: solid oxide fuel cells (SOFCs), multi-layer ceramic capacitors (MLCCs), resistor-capacitor, inductor-capacitor, varistor-capacitor multilayer combinations, and dye-sensitized solar cells, for example.

It is to be understood that the discussion of theory is included to assist in the understanding of the subject invention and is in no way limiting to the invention in its broad application.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of manufacture, said method comprising:
feeding a first quantity of a first additive manufacture material through a first high aspect ratio (HAR) nozzle to form a first disposed layer,
wherein the first HAR nozzle has a major axis to minor axis aspect ratio of greater than one.

2. The method of claim 1 wherein the first HAR nozzle has a major axis to minor axis aspect ratio of at least 1000.

3. The method of claim 1 wherein the first HAR nozzle has a major axis in a range of 0.001 mm to 500 mm.

4. The method of claim 3 wherein the first HAR nozzle has a major axis in a range of 1 mm to 500 mm.

5. The method of claim 4 wherein the first HAR nozzle has a major axis in a range of 5 mm to 50 mm.

6. The method of claim 1 wherein the first HAR nozzle has a minor axis in a range of 0.0005 mm to 5 mm.

7. The method of claim 6 wherein the first HAR nozzle has a minor axis in a range of 0.005 mm to 0.1 mm.

8. The method of claim 1 wherein the first additive manufacture material comprises a slurry or paste.

9. The method of claim 1 additionally comprising feeding an additional quantity of the first additive manufacture material through the first HAR nozzle to form a second layer disposed at least in part on or adjacent to the first disposed layer.

10. The method of claim 1 additionally comprising feeding a second quantity of a second additive manufacture material through a second nozzle to form a second layer, wherein,
the second layer is disposed at least in part on or adjacent to the first disposed layer when the second layer is formed subsequent to the first disposed layer and
the first disposed layer is disposed at least in part on or adjacent to the second layer when the first disposed layer is formed prior to second layer.

11. The method of claim 10 wherein at least one of the first and second additive manufacture material comprises a slurry or paste.

12. The method of claim 11 wherein both the first additive manufacture material and the second additive manufacture material comprise an identical slurry or paste.

13. The method of claim 11 wherein the second additive manufacture material differs in at least one of composition and viscosity from the first additive manufacture material.

14. The method of claim 10 wherein the second nozzle is a HAR nozzle having a major axis to minor axis aspect ratio of greater than one.

15. The method of claim 10 wherein the second nozzle is a circular nozzle.

16. In a method of additive manufacture wherein a slurry or paste additive manufacture material is processed to form a multi-layer object, the improvement comprising:
sequentially feeding individual quantities of the slurry or paste additive manufacture material through one or more HAR nozzles having a major axis to minor axis aspect ratio of greater than one to additively form the multi-layer object.

17. The improvement of claim 16 wherein at least one of said one or more HAR nozzles has a major axis to minor axis aspect ratio of at least 1000.

18. The improvement of claim 16 wherein the sequentially feeding of individual quantities of the slurry or paste additive manufacture material through one or more HAR nozzles comprises:
feeding a first quantity of a first slurry or paste additive manufacture material through a first said HAR nozzle,
followed by feeding an additional quantity of the first slurry or paste additive manufacture material through said first said HAR nozzle.

19. The improvement of claim 16 wherein the sequentially feeding of individual quantities of the slurry or paste additive manufacture material through one or more HAR nozzles comprises:
feeding a first quantity of a first slurry or paste additive manufacture material through a first said HAR nozzle,
followed by feeding a second quantity of the first slurry or paste additive manufacture material through a second said HAR nozzle.

20. The improvement of claim 16 wherein the sequentially feeding of individual quantities of the slurry or paste additive manufacture material through one or more HAR nozzles comprises:
feeding a first quantity of a first slurry or paste additive manufacture material through a first said HAR nozzle,
followed by feeding a second quantity of a second slurry or paste additive manufacture material through a second said HAR nozzle,
where the first and second slurry or paste additive manufacture materials differ in at least one of composition and viscosity.

21. The improvement of claim 16 wherein individual quantities in first consecutive sequentially feedings are the same.

22. The improvement of claim 21 wherein individual quantities in second consecutive sequentially feedings are different.

23. The improvement of claim 16 wherein individual quantities in first consecutive sequentially feedings are different.

24. The improvement of claim 16 wherein the second additive manufacture material differs in at least one of composition and viscosity from the first additive manufacture material.

25. The improvement of claim 16 additionally comprising feeding a quantity of a second slurry or paste additive manufacture material through one or more circular nozzles whereby a first layer disposed by the one or more HAR nozzles and a second layer disposed by the one or more circular nozzles are adjacent to each other.
